(19) United States
(12) Patent Application Publication
(10) Pub. No.: US 2003/0150259 A1
(43) Pub. Date: Aug. 14, 2003

(54) Device and method for measuring the injected-fuel quantity of injection systems, in particular for internal combustion engines of motor vehicles

(76) Inventors: Joachim Unger, Gerlingen (DE); Wolfram Von Huelsen, Gerlingen (DE); Hermann Bolle, Weingarten (DE); Ralf Bindel, Winterbach (DE); Ralf Haas, Illingen (DE); Dirk Wolf, Renningen (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/221,030

(22) PCT Filed: Dec. 19, 2001
(86) PCT No.: PCT/DE01/04797

(30) Foreign Application Priority Data
Jan. 8, 2001 (DE) 1 01 00 459.1

(51) Int. Cl. G01M 19/00

(52) U.S. Cl. 73/119 A; 73/118.1

(57) ABSTRACT

An apparatus (10) for measuring the injection quantity of injection systems (32), in particular for internal combustion engines in motor vehicles and especially in production testing, includes a measurement chamber (45). A connecting device (28) is also provided, by which at least one injection system (32) can be made to communicate with the measurement chamber (45) in pressuretight fashion. A piston (40) is passed through a wall of the measurement chamber (45). A detection device (58) is also provided, with which a motion of the piston (40) can be detected. To increase the measurement accuracy of the apparatus (10), it is proposed that the detection device (58) function in noncontacting fashion.

### PRIOR ART

The present invention first relates to an apparatus for measuring the injection quantity of injection systems, in particular for motor vehicles and especially in production testing, having a measurement chamber, a connecting device by which at least one injection system can be made to communicate with the measurement chamber in pressuretight fashion, having a piston which at least regionally defines the measurement chamber, and having a detection device, which detects a motion of the piston.

Such an apparatus is known on the market and is called an IQI (injection quantity indicator). It comprises a housing in which a piston is guided. The interior of the housing and the piston define a measurement chamber. The measurement chamber has an opening against which an injection system, for instance an injector with an injection nozzle can be placed in pressuretight fashion. If the injection system injects fuel into the measurement chamber, a fluid located in the measurement chamber is positively displaced. As a result, the piston moves, and this is detected by a travel sensor. From the piston travel, a conclusion can be drawn as to the change in volume in the measurement chamber, or in the fluid contained in it, and as a result as to the fuel quantity injected.

For measuring the motion of the piston, in the known injection quantity indicator, measuring is done with an assembly comprising a measuring tappet and an inductive travel measuring system. The measuring tappet is embodied as a feeler or is solidly connected to the piston. Upon a motion of the piston, the measuring tappet is accordingly set into motion, and finally the motion of the measuring tappet is detected, and a corresponding signal is carried to an evaluation unit.

The known injection quantity indicator already has very high accuracy. However, the unit comprising the measuring piston and the measuring tappet has a certain weight that in turn leads to a certain mass inertia of the unit. When testing fluid is injected into the measurement chamber through the injection system, it can therefore happen that the piston and the measuring tappet secured to it will execute a motion that does not exactly represent the increase in volume of the measurement fluid inside the measurement chamber. Especially at very small injection quantities, or in injections that comprise a plurality of partial injections in rapid succession, the result can therefore be inaccuracies in the volumetric measurement of injection quantities.

The present invention therefore has the object of refining an apparatus of the type defined at the outset such that with it, a measurement of the injection quantity of injection systems is possible with high resolution, high accuracy and great stability. In particular, even individual partial injection quantities during a total injection comprising a plurality of partial injections should be measurable.

This object is attained in that the detection device functions in noncontacting fashion.

It is attained by this provision that upon an injection of testing fluid into the measurement chamber, essentially only the mass of the piston has to be set into motion, but no measuring tappet or measuring feeler has to be moved with it. Thus the total mass of the unit to be set into motion upon an injection is reduced. The piston can accordingly respond much more spontaneously to a change in volume of the testing fluid in the measurement chamber; accordingly the piston stroke can follow the injection volume very directly and without superimposed vibrations.

Because the motion of the piston is not affected by an additional vibrating mass of a travel measuring system, the incident piston vibrations also become less, and fade more quickly for a given piston damping. Moreover, the load on the piston from inertial forces is also reduced, since the piston has no additional mass or essentially no additional mass. Deformation of the piston that can also cause a measurement error is thus reduced.

Advantageous refinements of the invention are recited in dependent claims.

It is optimal if the detection device has no parts that are connected to the piston. In that case, the mass to be set into motion upon an injection is minimal, making the desired effects in turn maximal.

In a refinement of the apparatus of the invention, it is proposed that the detection device functions capacitively. This makes for a particularly simple, precise, contactless measuring system. In a refinement of this capacitive measuring system, it is also proposed that the piston, or part of the piston, forms an electrode of a capacitor.

In another refinement, the detection device functions inductively and in particular includes an eddy current sensor. An eddy current sensor generally includes a half-open ferrite core, on which a magnet winding is disposed. If an alternating magnetic field is connected to the winding, the magnetic field lines emerge from the plane of the eddy current sensor, pass through the piston, and return into the ferrite core again. In the process, the alternating magnetic field generates eddy currents in the electrically conductive piston.

These eddy currents in the piston as a rule increase as the spacing between the eddy current sensor and the piston decreases. On the input side of the sensor coil, this change in the eddy currents can be evaluated by measurement technology by way of the change in the complex input impedance. It is especially advantageous if the frequency of the alternating magnetic field is relatively high, because then relatively high eddy currents are generated in the piston, and moreover, the penetration depth of the alternating magnetic field in the piston is relatively slight, which in turn further increases the measurement accuracy.

In addition, the detection device can also function by the laser triangulation method. In this method, the beam of a laser light source can be shaped by an optical element into a narrow beam cone, which generates a small visible light spot at a point of the piston oriented toward the laser light source. This measurement spot is projected by the projecting optical element onto a position-sensitive detector. If the spacing of the piston from the laser light source changes, the location where the projected beam strikes the detector shifts. From the image location, a reverse calculation can be made, to arrive at the spacing of the piston from the laser light source or from the detector. To prevent different reflection properties at different locations of the piston from adulterating the outcome of measurement, the light must be regulated.

A laser interferometer is also suitable for contactless travel measurement.

According to the invention, it is also proposed that the apparatus include a detection device which in turn has a laser Doppler vibrometer. This vibrometer functions on the principle of the Doppler frequency shift. The light from a laser light source is split into a measurement beam and a reference beam. The measurement beam is aimed at the piston. Some of the backscattered light is deflected via an optical element in such a way that the measurement beam and reference beam are superimposed on one another. This superposition creates an intensity modulation, whose frequency is proportional to the speed of motion of the piston. To detect the direction of piston motion, an acoustooptical modulator, for instance a so-called Bragg cell, can be used. From the speed and an outset position, the distance the piston has traveled can then be reverse calculated.

It should be noted at this point that it is entirely possible for a plurality of detection devices, operating by different principles, to be used with one and the same piston. This makes it possible not only to check the functioning of the individual detection devices, but also to perform an error compensation of the various detection devices, which means a considerable increase in the measurement accuracy.

The present invention also relates to a method for measuring the injection quantity of injection systems, in particular for motor vehicles and especially in production testing, in which a testing fluid is injected into a measurement chamber by an injection system, and in which the motion, caused by the injection, of a piston passed through a wall of the measurement chamber is detected.

To increase the measurement accuracy of the injection quantity, it is proposed according to the invention that the motion of the piston is detected in noncontacting fashion. This contactless measurement of the piston motion can be done by each of the methods described above.

Below, two exemplary embodiments of the invention are described in detail in conjunction with the accompanying drawing. Shown in the drawing are:

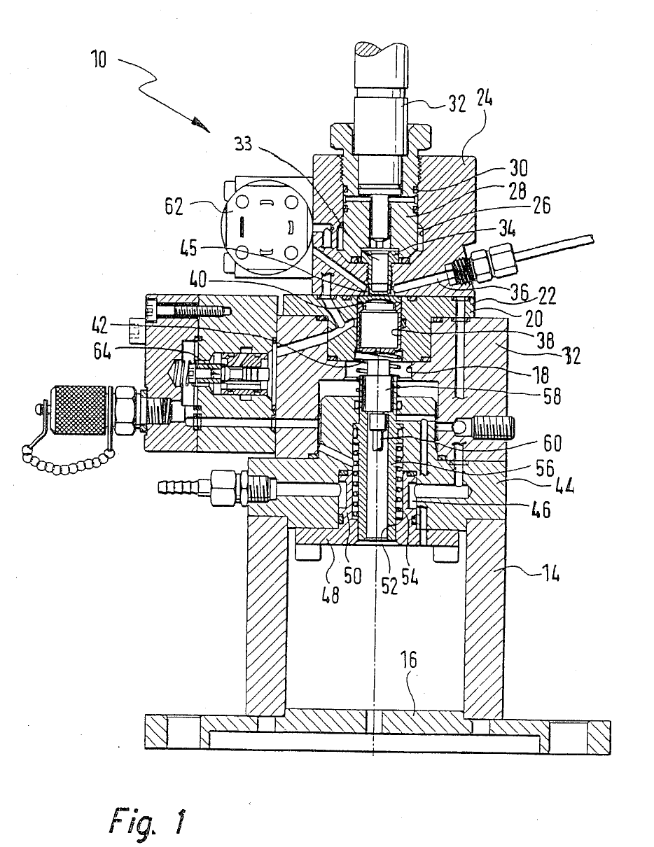

FIG. 1, a section through a first exemplary embodiment of an apparatus for measuring the injection quantity of injection systems; and

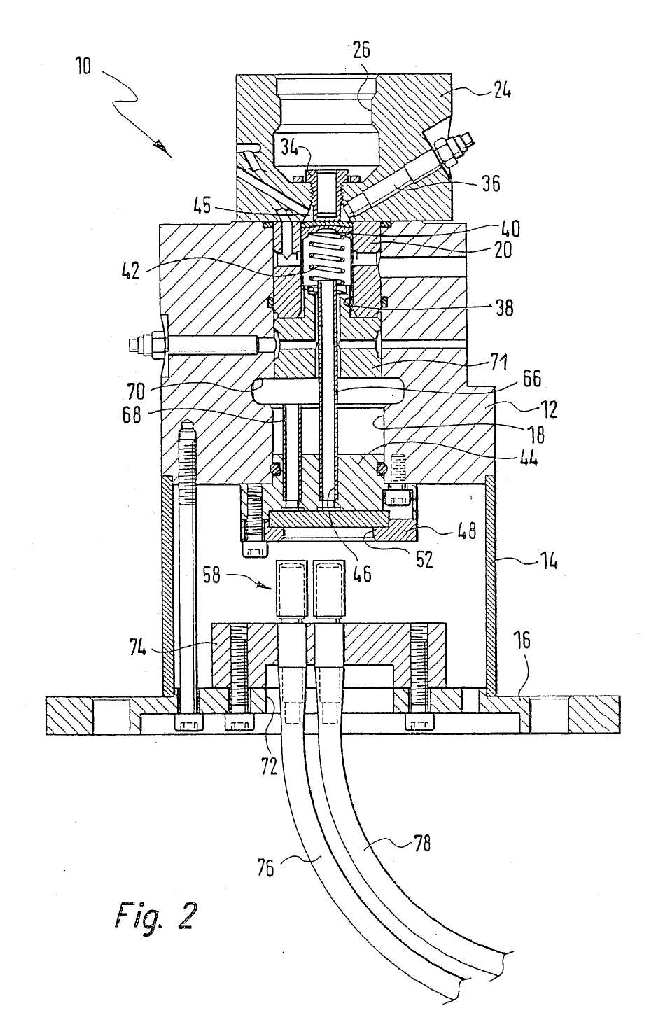

FIG. 2, a view similar to FIG. 1, through a second exemplary embodiment of an apparatus for measuring the injection quantity of injection systems.

In FIG. 1, an apparatus for measuring the injection quantity of injection systems is identified overall by reference numeral 10. It includes a centrally disposed body 12, which is retained on a sleeve 14. The sleeve stands in turn on a base plate 16. The fixation of the apparatus 10 is effected on the base plate 16.

A substantially central stepped bore 18 is made in the central body 12. Inserted into the uppermost portion of the bore is a cylindrical insert 20, which is braced with a collar 22 on the top side of the central body 12. A head 24 is placed in pressuretight fashion on the insert 20, and a stepped bore 26 is also made in the head; this bore, in the assembled state shown in FIG. 1, extends coaxially with the stepped bore 18. An adaptor 28 is inserted from above into the stepped bore 26 and is sealed off from the stepped bore 26 by O-rings 30. An injection system, in this case an injector 32, is inserted with its injection nozzle 33 into the adaptor 28. The injector 32 communicates in turn with a high-pressure testing fluid supply (not shown). An injection damper 34 is inserted into the lower region of the stepped bore 26 in the head 24. The temperature in the lower region of the stepped bore 26 is detected by a temperature sensor 36.

A bore 38 is also present in the insert 20; in the installed position shown in FIG. 1, this bore extends coaxially to the stepped bore 18 and to the stepped bore 26. A piston 40 is guided slidingly in the bore 38. The piston 40 is pressed upward by a helical spring 42, which is braced on a measurement transducer receptacle 44. A measurement chamber 45 is defined by the top side of the piston 40, by the lower, unthreaded region of the injection damper 34, and by the lower region of the stepped bore 26. The piston 40 is embodied as a closed hollow body.

A stepped bore 46 is also present in the measurement transducer receptacle 44; in the installed position shown in FIG. 1, this stepped bore is likewise coaxial with the other stepped bores 18, 26 and 38. A receptacle 48 for a helical spring 54 is screwed onto the underside of the measurement transducer receptacle 44. This receptacle 48, with an extension 50, engages the lower region of the stepped bore 46 and itself also has a central stepped bore 52.

The helical spring 54 is braced on a shoulder of the stepped bore 52. It presses a sensor mount 56 upward against a radially inward-pointing collar of the measurement transducer receptacle 44. The sensor mount 56 is tubular overall, and an eddy current sensor 58 is screwed into its upper region in such a way that the upper end of this sensor is at a slight spacing below the lower end of the piston 40. A connection cable 60 of the eddy current sensor 58 is extended to the outside through the tubular sensor mount 56 and the receptacle 48 for the helical spring 54 and is connected to an evaluation device, not shown in the drawing.

An electromagnetically actuatable evacuation valve 62 is also mounted to the left of the head 24 in the drawing, and through it the testing fluid can be drained out of the measurement chamber 45. An equal-pressure valve 64 is also mounted on the left of the central body 12, and this valve, even at quite variable gas pressures below the piston 40, assures an evacuation rate from the measurement chamber 45 that is virtually independent of the gas pressure below the piston 40, when the electromagnetically actuatable evacuation valve 62 is open.

Another function of the equal-pressure valve 64 is to regulate the pressure in a groove (not identified by reference numeral), extending in the insert 20 radially all the way around the piston, to a slightly lower pressure than in the measurement chamber 45. Because of the defined slight pressure difference between the measurement chamber 45 and the groove, gap leakages between the piston 40 and the insert 20 are kept virtually constant and moreover are kept very slight. The magnitude of this virtually constant slight leakage is detected by software in the evaluation device. Also by means of the equal-pressure valve 64, the “gas consumption” of the apparatus 10 is reduced, when the apparatus 10 is operated at a gas pressure below the piston 40 that is higher than the ambient air pressure.

The apparatus 10 for measuring the injection quantity of an injection system 32, as shown in FIG. 1, functions as follows:

Via the high-pressure testing fluid supply, testing fluid (not shown) is delivered to the injection system 32 and its injection nozzle 33 and injected, via the injection damper 34, into the measurement chamber 45 that is also filled with testing fluid. By means of the injection damper 34, the injection streams are prevented from striking the top side of the piston 40 directly. A direct impact of the injection streams on the piston 40 could set it to vibrating, and this vibration would not be equivalent to the actual course of the injection. As a result of the injection of testing fluid into the measurement chamber 45, the testing fluid volume in the measurement chamber 45 increases. The volume additionally reaching the measurement chamber 45 accelerates the piston 40 in its downward motion, counter to the force of the helical spring 42 and to the gas pressure below the piston 40. As a result, the spacing between the underside of the piston 40 and the eddy current sensor 58 changes.

This change in the spacing between the eddy current sensor 58 and the underside of the piston 40 is detected by the eddy current sensor 58 in the following way: The eddy current sensor 58 includes, among other elements, a winding, not shown. An alternating magnetic field is applied to the winding. The field lines of this alternating magnetic field penetrate the lower boundary wall or bottom of the closed piston 40. As a result of the alternating magnetic field, eddy currents are generated in this bottom of the piston 40.

These eddy currents in the bottom of the piston 40 increase as the spacing between the eddy current sensor 58 and the bottom of the piston 40 decreases. On the input side of the winding of the eddy current sensor 58, these changes in the eddy currents cause changes in the complex input impedance. These changes are evaluated by measurement technology in the evaluation unit, and from that a distance by which the piston bottom, and hence the piston 40 itself, have moved is determined.

To make it possible to achieve the least possible penetration depth of the alternating magnetic field into the bottom of the piston 40, which in turn makes it possible to construct a piston 40 with a lesser wall thickness and thus with a lower mass, it is advantageous on the one hand to use an alternating field of high frequency and on the other a material for the piston or the piston bottom that has the highest possible electrical conductivity. At the same time, naturally, the material itself should be as lightweight as possible. This is the case with aluminum, for instance.

In the apparatus 10, the parts to be moved upon an injection can thus be kept as small as possible in terms of their mass. There is no need for additional components of the detection device to be moved. Because of this low moved mass, the piston 40 can essentially directly follow the volume of testing fluid injected by the injection nozzle 33. Thus even the slightest injection quantities can be measured with high accuracy, as can partial injections in immediate succession within a total injection. Furthermore, the incident vibration of the piston 40 is less and also fades faster.

In FIG. 2, a further exemplary embodiment of an apparatus 10 for measuring the injection quantity of injection systems is shown. Those components that are functionally equivalent to elements that have already been described in conjunction with FIG. 1 and are shown in it carry the same reference numerals in FIG. 2 and will not be described again in detail. For the sake of simplicity, only some differences between the apparatus 10 shown in FIG. 2 and the apparatus 10 shown in FIG. 1 will be addressed in more detail:

First, it must be noted that the piston 40 in FIG. 2 is not closed but instead is open on its underside. A central tube 66 is introduced into this opening, coaxially with the piston 40 and the stepped bore 18. The central tube 66 extends from the lower peripheral region of the piston 40 perpendicularly downward to approximately the level of the intermediate element 44.

Next to the central tube 66, and thus outside the center axis of the stepped bores 18, 26 and 46, a reference tube 68 is provided, whose longitudinal axis extends parallel to the longitudinal axis of the central tube 66. The reference tube 68 also extends from the intermediate element 44 to the lower edge of a hollow chamber 70, which is provided in the central body 20 and is bounded at the top by a cylindrical part 71 that is inserted into the stepped bore 18 in the central body 12. Located below the intermediate element 44 is a glass disk (not identified by reference numeral), which is retained by an annular holder 48. This glass disk makes it possible to achieve a pressure in the hollow chamber 70 that is different from that in the environment.

In the apparatus 10 shown in FIG. 2, the base plate 16 has a central opening 72, and a holder 74 embodied as a rib is screwed onto the top side of the base plate 16. The ends of two fiber-optic waveguides 76 and 78 are in turn held by this holder 74. The ends of the waveguides 76 and 78 are oriented such that one end is coaxial to the central tube 66, and the other end is coaxial to the reference tube 68. The other ends, not visible in FIG. 2, of the two waveguides 76 and 78 are connected via various optical components to a laser light source and to the other sensors and evaluation electronics of a laser Doppler vibrometer.

The laser beam transmitted by the waveguide 78 and emerging from its end extends coaxially to the central tube 66 and strikes the underside of the upper boundary wall of the piston 40. The corresponding laser beam that emerges from the end of the waveguide 76 is coaxial with the reference tube 68 and strikes the underside of the cylindrical part 71. The measurement beam reflected by the piston 40 and the reference beam reflected by the cylindrical part 71 are superimposed in the optical system.

In this superposition, an intensity modulation is created, whose frequency is proportional to the speed of motion of the object being measured. To enable detecting the speed of motion, an acoustooptical modulator or so-called Bragg cell is used. From the speed of the piston 40, the distance traveled by the piston 40 upon an injection by the injection nozzle 33 can be determined, and from that in turn the quantity of testing oil injected can be ascertained.

The measurement accuracy of a laser Doppler vibrometer is very high, so that even the tiniest injection quantities can be reliably detected. The mass that must be moved in an injection is very small, since on the one hand the piston 40 is open, and on the other, the contactless measuring device requires no additional parts on the piston 40. It is understood that a single-point Doppler laser vibrometer could also be used.

In an exemplary embodiment not shown, the piston forms one electrode of a capacitor. In that case, the distance traveled by the piston 40 and from that the injected fluid quantity can be learned on the basis of the change in capacity that ensues upon a motion of the piston 40. It is also possible for the detection device to be embodied with a laser triangulation method. A laser interferometer is also usable.

It should also be expressly stated at this point that an apparatus is also conceivable in which a plurality of different contactless detection devices are used on the same piston. This makes it possible to monitor the functioning of the apparatus. Moreover, the various detection devices can be calibrated relative to one another, and system-specific magnitudes of error can be filtered out. As a result, a further major improvement in the measurement accuracy is possible.

1. An apparatus (10) for measuring the injection quantity of injection systems (32), in particular for motor vehicles and especially in production testing, having a measurement chamber (45), a connecting device (28) by which at least one injection system (32) can be made to communicate with the measurement chamber (45) in pressuretight fashion, having a piston (40) which at least regionally defines the measurement chamber (45), and having a detection device (58), which detects a motion of the piston (40), characterized in that the detection device (58) functions in noncontacting fashion.

2. The apparatus of claim 1, characterized in that the detection device (58) has no parts that are connected to the piston (40).

3. The apparatus of one of claims 1 or 2, characterized in that the detection device functions capacitively.

4. The apparatus of claim 3, characterized in that the piston, or part of the piston, forms an electrode of a capacitor.

5. The apparatus of one of the foregoing claims, characterized in that the detection device functions inductively and in particular includes an eddy current sensor (58).

6. The apparatus of one of the foregoing claims, characterized in that the detection device functions by the laser triangulation method.

7. The apparatus of one of the foregoing claims, characterized in that the detection device includes a laser interferometer.

8. The apparatus of one of the foregoing claims, characterized in that the detection device includes a laser Doppler vibrometer.

9. A method for measuring the injection quantity of injection systems (32), in particular for motor vehicles and especially in production testing, in which a testing fluid is injected into a measurement chamber (45) by an injection system (32), and the motion, caused by the injection, of a piston (40) passed through a wall of the measurement chamber (45) is detected, characterized in that the motion of the piston (40) is detected in noncontacting fashion.
